(19) United States
(12) Patent Application Publication
(10) Pub. No.: US 2008/0172135 A1
(43) Pub. Date: Jul. 17, 2008

(54) DEVICE AND METHOD FOR CONTROLLING FUNCTIONAL STATUS OF A COMPUTER REMOTELY

(76) Inventor: Haim Mordechay FROILICH, Bnei Brak (IL)

Correspondence Address: SOROKER-AGMON ADVOCATE AND PATENT ATTORNEYS, NOLTON HOUSE, 14 SHENKAR STREET, HERZELIYA PITUACH, 46725, omitted

(21) Appl. No.: 11/622,000

(22) Filed: Jan. 11, 2007

(51) Int. Cl. G05B 19/18

(52) U.S. Cl. 700/65

(57) ABSTRACT

A device for remotely controlling the functional status of a computer, including an input that is adapted to receive telephone calls or SMS messages, an output that is coupled to the motherboard of the computer and adapted to communicate with the motherboard of the computer, an electronic circuit that is adapted to control the output responsive to instructions provided to the input; and wherein the device is adapted to turn on the computer responsive to instructions provided to the input by a remote transmission.

### FIELD OF THE INVENTION

The present invention relates generally to controlling the functional status of a computer remotely.

### BACKGROUND OF THE INVENTION

With the advance of communications and computers it has become common for a person to access remote computers, for example over the Internet or over telephone lines. Typically remote access enables the person to retrieve information from the remote computer and/or perform programs available therein. Accessing remote computers allows people to work from home and/or to transfer data from one computer to another, for example for a person working on computers at two locations.

A basic condition for using a computer remotely is that the computer be turned on and in normal working condition. If however the computer is not turned on or the computer is not responding to commands, generally intervention is required wherein a person is required to physically turn on the computer or restart the computer by pressing the activation button or reset button on the front panel of the computer. Some common cases where such intervention is required include, restarting the computer after a power failure, resetting the computer after a program crash that halted the operating system, turning on the computer when the person forgot to leave it on or left it off intentionally to preserve energy.

In U.S. patent application Ser. No. 4,701,946 the disclosure of which is incorporated herein by reference there is described a device for controlling the application of power to a computer so that the computer may be powered on responsive to an incoming call for the duration of the call. The computer is then able to communicate via a modem with the caller.

Generally in older computers if the power switch was left in the on position it was sufficient to provide power to the power supply of the computer in order to turn it on. However in modern personal computers (e.g. with ATX power supplies) the computer is not activated merely by supplying power to the power supply of the computer. Instead the power supply is adapted to receive instructions from the motherboard of the computer, for example when the user presses the activation switch; a connection is shorted on the motherboard of the computer, and the motherboard then signals the power supply to turn on. The method of turning the computer on and off by control of the motherboard has the advantage that the motherboard can notify the software running in the computer to prepare itself for being shut down and prevent damage to files.

### SUMMARY OF THE INVENTION

An aspect of an embodiment of the invention, relates to a device that controls the functional status of a computer by providing signals to the motherboard of the computer, responsive to remote communications with the device, for example by accepting telephone calls via telephone lines or by accepting telephone calls or SMS messages over a wireless communication network. In an exemplary embodiment of the invention, the device answers telephone calls and accepts commands, for example provided by the caller using DTMF. In an exemplary embodiment of the invention, the commands instruct the device to perform various tasks related to controlling the status of the computer, for example turning on the computer, turning on the computer for a limited amount of time, turning off the computer immediately or after a delay or performing a hard reset of the computer immediately or at a later time. Optionally, the device accepts other commands from the caller to program the device, for example setting the time of an internal clock or providing a list of passwords.

In an exemplary embodiment of the invention, the device provides notification to the caller after performing the action during the call session. Alternatively or additionally, the device calls the caller back using the option of calling the last caller, which is provided by many telephone service providers or by calling an identified number if the service provider provides this service.

In some embodiments of the invention, the device is installed as a card in the computer encasement. Optionally, with a port that is accessible from the back of the computer. Alternatively, the device may be installed external to the computer with wires entering the computer encasement.

In some embodiments of the invention, the device is powered by electricity provided by the telephone lines or from the power provided by the ring signal. Alternatively or additionally, the device is provided with a battery or draws power from the power supply of the computer, for example via the data bus of the motherboard or directly.

There is thus provided according to an exemplar embodiment of the invention, a device for remotely controlling the functional status of a computer, comprising, an input that is adapted to receive telephone calls or SMS messages, an output that is coupled to the motherboard of the computer and adapted to communicate with the motherboard of the computer, an electronic circuit that is adapted to control the output responsive to instructions provided to the input, and wherein the device is adapted to turn on the computer responsive to instructions provided to the input by a remote transmission. In some embodiments of the invention, the input is adapted to receive telephone calls through a telephone line. Alternatively or additionally, the input is adapted to receive telephone calls wirelessly. Optionally, the output is coupled to the motherboard of the computer with a wire.

In an exemplary embodiment of the invention, the output communicates with the motherboard by shorting the leads of a jumper on the motherboard for a pre-selected amount of time. Optionally, the circuit emulates an IVR to accept information from a remote caller. In an exemplary embodiment of the invention, the circuit manages a list of caller passwords and telephone numbers for contacting them. Optionally, the device is adapted to provide confirmation to a caller upon performing an action requested by the caller. In an exemplary embodiment of the invention, the confirmation is provided by sending an SMS or a FAX to the caller. Alternatively or additionally, the confirmation is provided by calling the caller and providing a voice message. In an exemplary embodiment of the invention, the device is additionally adapted to turn off the computer responsive to instructions provided to the input. Optionally, the device is additionally adapted to reset the computer responsive to instructions provided to the input. In an exemplar embodiment of the invention, the device is adapted to perform the requested instruction with a time delay. Optionally, the size of the time delay is provided by the transmission.

In an exemplary embodiment of the invention, the device is adapted to perform the requested instruction at a specific time. Optionally, the specific time is provided by the transmission. In an exemplary embodiment of the invention, the device further includes a battery to power the device. Alternatively or additionally, the device draws power from the power supply of the computer. Further alternatively or additionally, the device draws power from the telephone line. Optionally, the device is adapted to warn people in the vicinity of the computer that it is going to perform an action that will affect the status of the computer. In an exemplary embodiment of the invention, the device is positioned inside the encasement of the computer. Alternatively, the device is positioned outside the encasement of the computer.

### BRIEF DESCRIPTION OF THE DRAWINGS

The present invention will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of implementation of a device for controlling functionality of a computer, according to all exemplary embodiment of the invention;

FIG. 2 is a flow diagram of a method of using a device for controlling functionality of a computer, according to an exemplary embodiment of the invention;

FIG. 3 is a schematic illustration of installation of a device for controlling functionality of a computer, according to an exemplary embodiment of the invention; and

FIG. 4 is a schematic illustration of a circuit for a device for controlling functionality of a computer, according to an exemplary embodiment of the invention.

### DETAILED DESCRIPTION

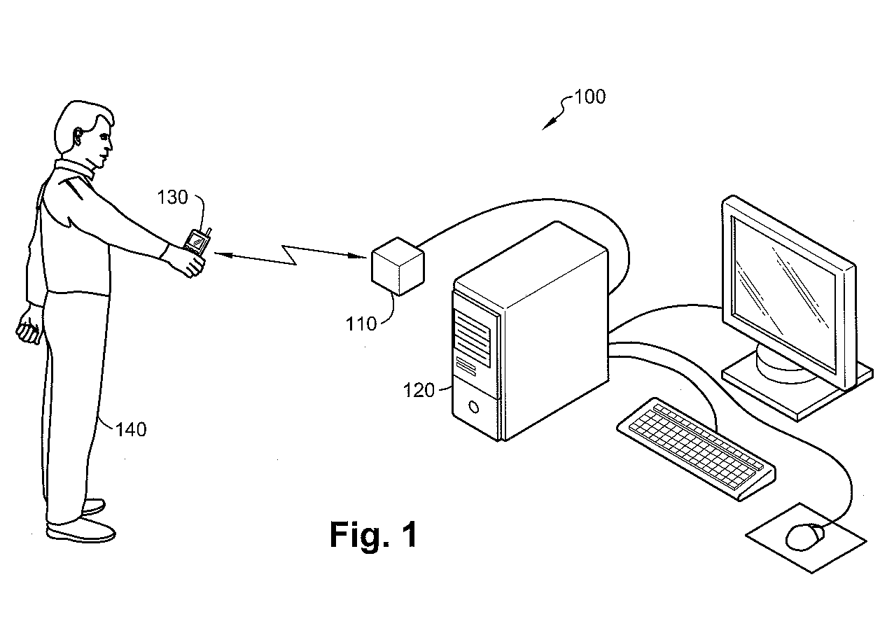

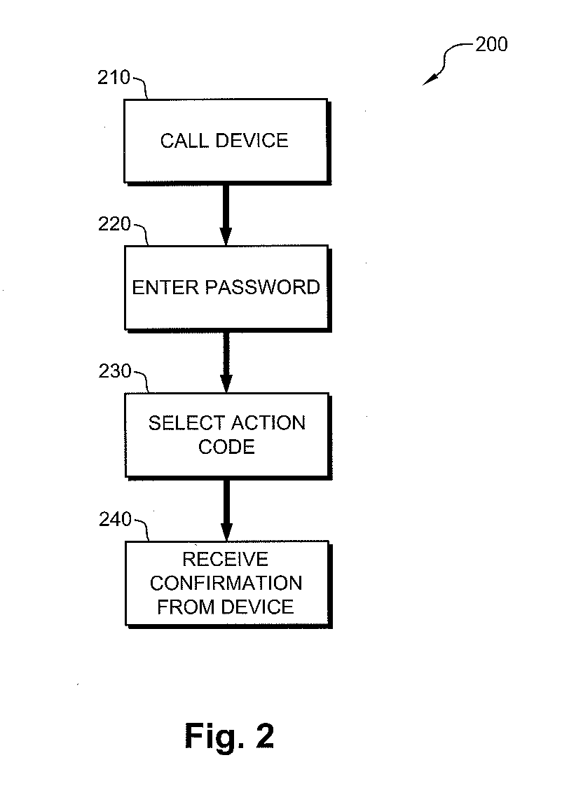

FIG. 1 is a schematic illustration 110 of implementation of a device 110 for controlling functionality of a computer, according to an exemplary embodiment of the invention. In an exemplary embodiment of the invention, device 110 is installed with a direct connection 115 to the motherboard of a computer 120. FIG. 2 is a flow diagram of a method 200 of using device 110 for controlling functionality of computer 120, according to an exemplary embodiment of the invention. Optionally, a remote caller 140 that wants to turn on computer 120 places a call (210) using a communication device 130 (e.g. a telephone or mobile telephone) to device 110 in order to control the functionality of computer 120. In an exemplary embodiment of the invention, device 110 answers the call using an internal IVR (interactive voice response system) and provides caller 140 with various options, for example a message requesting that caller 140 enter (220) a password, which can be provided for example by keying in a pre-selected number using the telephone buttons. Optionally, after authenticating caller 140, device 110 requests that caller 140 select (230) an action code to designate the action that caller 140 wants device 110 to perform. Optionally, device 110 can be instructed to turn on computer 120, turn off computer 120, and reset computer 120. In some embodiments of the invention, the device can also put computer 120 into sleep mode or wake computer 120 out of sleep mode or perform other functions if they are enabled to be performed by switches on the front panel of computer 120 or jumpers on the motherboard of the computer. In an exemplary embodiment of the invention, each of the above functions can be performed immediately, after a time delay, or at a selected time. Optionally, the time for the delay or for performing the function (e.g. alter 10 minutes from the call) may be pre-selected or keyed in by caller 140.

In some embodiments of the invention, caller 140 receives (240) from device 110 a voice message or other pre-defined signals (e.g. a specific beep or tone) indicating that the function was acknowledged or performed (e.g. if it is an immediate function). In an exemplary embodiment of the invention, device 110 provides confirmation to caller 140 by calling back the last caller if such a service is provided by the telephone service company. Alternatively, device 110 may use a caller recognition system to identify the number of caller 140 to call the caller back and provide confirmation. In some embodiments of the invention, device 110 may be pre-programmed with a list of callers and telephone numbers associated with their passwords so that device 110 can call the user back to confirm performance of the requested function. Optionally, the list may be transmitted to device 110 from a computer by calling the device and transmitting the list with a modem. In some embodiments of the invention, device 110 may notify the caller by other methods, for example by sending an SMS message or FAX message to caller 140 to confirm performance of the function.

In an exemplary embodiment of the invention, device 110 may toggle the functional status of computer 120 responsive to the ring signal of an incoming call. Optionally, such an option is useful if device 110 is connected to a dedicated line. In some embodiments of the invention, device 110 can be activated by an SMS message, which may contain a caller's password and an action code and/or other parameters.

In some embodiments of the invention, device 110 allows the caller to request that device 110 forward the call to another device which is connected to the telephone line, for example a fax machine or an answering machine. Optionally, if device 110 determines that the call is not intended for it, it forwards the call automatically.

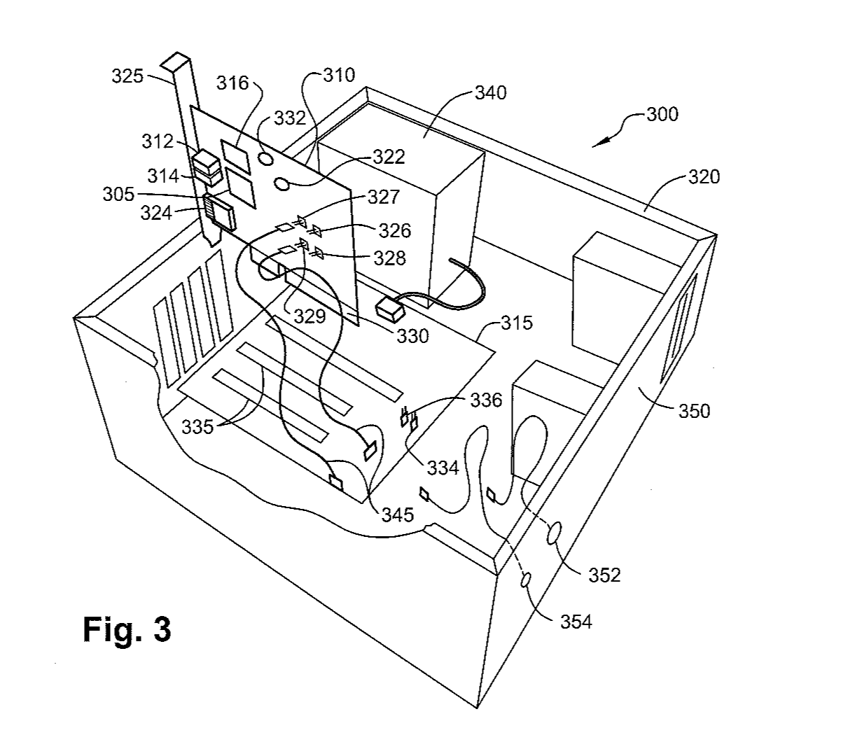

FIG. 3 is a schematic illustration of installation of device 110 for controlling functionality of computer 120, according to an exemplary embodiment of the invention. In an exemplary embodiment of the invention, device 110 is implemented as a computer card 310 with an electronic circuit 305, which is installed inside a computer encasement 320 of computer 120. Optionally, card 310 includes a bus connector 330, which is placed into a bus socket 335 on a motherboard 315 with a back-panel 325 facing out of encasement 320 to allow external access to card 310 without opening encasement 320 after card 310 is installed. In some embodiments of the invention, card 310 is connected physically by having the shape of a bus connector but without electronic connections to bus socket 335. Alternatively, card 310 may be implemented as an extension to back-panel 325 without any connection to bus sockets 335.

In an exemplary embodiment of the invention, card 310 includes a line in socket 312 for connecting to a telephone line to accept calls. Optionally, card 310 also includes a line out socket 314 to allow other devices to connect to the telephone line so that they can use the line when it is not in use by card 31.0 or allow card 310 to forward calls to them. In some embodiments of the invention, card 310 includes a mobile telephone reception and transmission system (e.g. using a SIM (subscriber identity module) card), which enables card 310 to function as a mobile telephone with or without being additionally connected to a wire based telephone system.

In some embodiments of the invention, card 310 includes a battery 322 to provide power to card 310 continuously, so that it may support various options such as an internal clock in addition to performing the functions as described above. In some embodiments of the invention, card 310 draws power from a power supply 340, which provides the power to the internal devices of computer 120. Optionally, card 310 may draw the power from power supply 340 via bus socket 335 or directly (e.g. with a direct cable like a disk drive) to perform its required functions. In some embodiments of the invention, card 310 does not require additional external power and functions solely from the power provided by the telephone line or from the power provided by the ring signal.

In some embodiments of the invention, card 310 includes a speaker 332 to provide audio signals giving indication or warning to people using computer 120 or in the vicinity of the computer that card 310 is about to perform a function, for example to warn people that computer 120 is about to be reset. Optionally, card 310 may provide a method for a person located in the vicinity of the computer to override an action requested remotely by remote caller 140, for example if a person working on computer 120 presses the power on button or reset button when card 310 gives a warning signal, card 310 will cancel the action.

In some embodiments of the invention, card 310 may be provided as a kit with a computer program to program card 310 via bus connector 330 or by dialing card 310 from a remote computer with a modem, and provide control options as described above, for example a caller list with telephone numbers and passwords. Alternatively or additionally, card 310 may be programmed by calling the card and keying in commands (e.g. action codes and time values) during the telephone session. In some embodiments of the invention, card 310 includes switches 324 or jumpers to set various parameters of card 310, for example the number of rings before card 310 responds to a telephone call, the time delay before performing an action or the code symbol for a specific action. Optionally, switches 324 may be positioned in various places, for example on back-panel 325 so they can be accessed without opening encasement 320, or they may be positioned on circuit 305 or in other positions on card 310 so that they can be set before installing card 310.

In an exemplary embodiment of the invention, computer encasement 320 is provided with a front panel 350 with a power switch 352 to turn on the computer and a reset switch 354 to perform a hard reset to computer 120. Power switch 352 is generally connected to a power on jumper 334 on motherboard 315 and reset switch 354 is also connected to a reset jumper 336 on motherboard 315. When power on switch 352 is pressed it shorts the leads of jumper 334 and causes motherboard 315 to notify power supply 340 to provide the power required for computer 120 to go on. Likewise when reset switch 354 is pressed it shorts the leads of reset jumper 336 and causes motherboard 315 to initiate a hard reset and restart computer 120. Additionally, when power on switch 352 is held for more than a few seconds it instructs the motherboard to turn off computer 120. In an exemplary embodiment of the invention, card 31.0 includes a power in jumper 326, a power out jumper 327, a reset in jumper 328 and a reset out jumper 329. Optionally, the wires that connect power switch 352 and reset switch 354 from front panel 350 to power on jumper 334 and reset jumper 336 on motherboard 315 are disconnected and connected to power in jumper 326 and reset in jumper 328 on card 310 respectively. Optionally, bypass wires 345 are provided to connect power out jumper 327 and reset out 329 to power on jumper 334 and reset jumper 336, thus enabling card 310 to control (e.g. intercept and/or initiate) powering on and resetting of computer 120. Optionally, card 310 is connected in parallel to power on switch 352 and reset switch 354 so that the computer can be controlled normally in addition to the control by card 310.

In some embodiments of the invention, the above connection of the reset jumpers and power on jumpers may be performed by soldering wires to card 310 or to motherboard 315 if jumpers are not readily available. Optionally, card 310 may be provided internally as described above or externally, for example with its own dedicated encasement as shown in FIG. 1 as device 110.

In an exemplary embodiment of the invention, device 110 may be used for controlling the functional status of a laptop or any other type of computer that is powered on and off by control of the motherboard, by connecting wires directly to the motherboard of the computer or laptop computer.

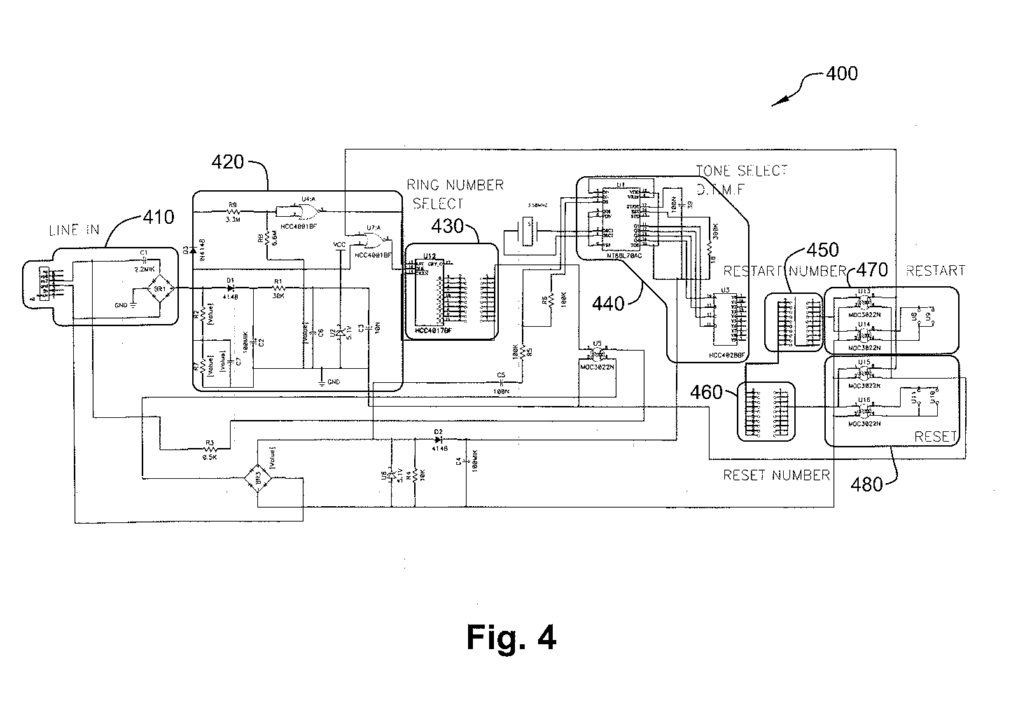

FIG. 4 is a schematic illustration of a circuit 400 for device 110 for controlling functionality of a computer, according to an exemplar embodiment of the invention. In an exemplary embodiment of the invention, circuit 400 is adapted to accept a call from a telephone line and accumulate power for powering the circuit resulting from the ring of the call and call signals. Optionally, circuit 400 accepts tone signals with codes indicating what action should be taken, then circuit 400 outputs a signal to motherboard 315 to perform the selected action.

In an exemplary embodiment of the invention, circuit 400 comprises the following main parts:

1. A line in, circuit segment 410—circuit segment 410 is connected to a telephone line with line in socket 312. Optionally, circuit segment 410 accepts the call and provides the signal to circuit segment 420.

2. A power accumulation, circuit segment 420—circuit segment 420 accumulates power from the call for powering the circuit without use of an additional power source.

3. A ring number select, circuit segment 430—circuit segment 430 comprises a set of switches for selecting the number of rings before device 110 answers the call.

4. A tone select, circuit segment 440—circuit segment 440 analyzes the tones from the call signal to determine what action should be taken.

5. A restart number selector, circuit segment 450—circuit segment 450 selects the code that caller 140 needs to provide to cause device 110 to turn on computer 120 or turn off computer 120. Optionally, circuit segment 450 may provide two separate values; one for turning on computer 120 and one for turning off computer 120.

6. A reset number selector, circuit segment 460—circuit segment 460 selects the code that caller 140 needs to provide to cause device 110 to reset computer 120.

7. A restart control, circuit segment 470—circuit segment 470 controls the output of circuit 400, which signals motherboard 315 to power on or power off computer 120. In some embodiments of the invention, circuit segment 470 is also used to put the computer into sleep mode and take it out of sleep mode, for example dependent on the amount of time used to short power on jumper 334, the previous state of computer 120 and the settings in the BIOS of the computer.

8. A reset control, circuit segment 480—circuit segment 480 controls the output of circuit 400, which signals motherboard 315 to perform a hard reset for the computer.

It should be noted that the exact details of the circuit implementation described above are only exemplary and other variations may be implemented to provide other options, provide the same options in a different manner, or to remove some of the options.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

It will be appreciated by persons skilled in the art that the present invention is not limited to what has been particularly shown and described hereinabove. Rather the scope of the present invention is defined only by the claims, which follow.

1. A device for remotely controlling the functional status of a computer, comprising:
an input that is adapted to receive telephone calls or SMS messages;
an output that is coupled to the motherboard of the computer and adapted to communicate with the motherboard of the computer;
an electronic circuit that is adapted to control said output responsive to instructions provided to said input; and
wherein said device is adapted to turn on the computer responsive to instructions provided to said input by a remote transmission.

2. A device according to claim 1, wherein said input is adapted to receive telephone calls through a telephone line.

3. A device according to claim 1, wherein said input is adapted to receive telephone calls wirelessly.

4. A device according to claim 1, wherein said output is coupled to the motherboard of the computer with a wire.

5. A device according to claim 1, wherein said output communicates with the motherboard by shorting the leads of a jumper on the motherboard for a pre-selected amount of time.

6. A device according to claim 1, wherein said circuit emulates an IVR to accept information from a remote caller.

7. A device according to claim 1, wherein said circuit manages a list of caller passwords and telephone numbers for contacting them.

8. A device according to claim 1, wherein said device is adapted to provide confirmation to a caller upon performing an action requested by the caller.

9. A device according to claim 8, wherein said confirmation is provided by sending an SMS or a FAX to said caller.

10. A device according to claim 8, wherein said confirmation is provided by calling said caller and providing a voice message.

11. A device according to claim 1, wherein said device is additionally adapted to turn off the computer responsive to instructions provided to said input.

12. A device according to claim 1, wherein said device is additionally adapted to reset the computer responsive to instructions provided to said input.

13. A device according to claim 1, wherein said device is adapted to perform the requested instruction with a time delay.

14. A device according to claim 13, wherein the size of said time delay is provided by said transmission.

15. A device according to claim 1, wherein said device is adapted to perform the requested instruction at a specific time.

16. A device according to claim 15, wherein said specific time is provided by said transmission.

17. A device according to claim 1, further comprising a battery to power said device.

18. A device according to claim 1, wherein said device draws power from the power supply of the computer.

19. A device according to claim 1, wherein said device draws power from the telephone line.

20. A device according to claim 1, wherein said device is adapted to warn people in the vicinity of the computer that it is going to perform an action that will affect the status of the computer.

21. A device according to claim 1, wherein said device is positioned inside the encasement of the computer.

22. A device according to claim 1, wherein said device is positioned outside the encasement of the computer.
